(19) United States
(12) Patent Application Publication
(10) Pub. No.: US 2015/0278759 A1
(43) Pub. Date: Oct. 1, 2015

(54) System and Method for Vehicle Delivery Tracking Service

(71) Applicant: Go Taxi Truck, LLC, Brooklyn, NY (US)

(72) Inventors: William HARRIS, Brooklyn, NY (US); Rudy CALLEGARI, Brooklyn, NY (US); Greg CALLEGARI, West Hills, NY (US); Stephen Robert BACSO, Brooklyn, NY (US); Nick Eugene FOISY, Brooklyn, NY (US)

(21) Appl. No.: 14/669,825

(22) Filed: Mar. 26, 2015

Related U.S. Application Data
(60) Provisional application No. 61/970,700, filed on Mar. 26, 2014.

(51) Int. Cl. G06Q 10/08; H04L 29/08

(52) U.S. Cl. CPC G06Q 10/08355; H04L 67/10; H04L 67/12; G06Q 10/0838

(57) ABSTRACT

Systems and methods including receiving, via a software application, delivery task attributes over a network for delivering a physical load from a source to a destination, the delivery task attributes including at least source specifications, destination specifications and load attributes, automatically generating routing information for the physical load based on at least one of the delivery task attributes, automatically assigning a transportation resource to the delivery task based on at least one of the delivery task attributes and transportation resource attributes, transmitting a dispatch over the network to the assigned transportation resource, the dispatch including the routing information and at least one of the delivery task attributes, receiving delivery monitoring information during an execution of the delivery task, and transmitting a notification over the network to at least one of the assigned transportation resource and a user of the software application of the delivery monitoring information.

### RELATED APPLICATION

The present application claims priority to U.S. Provisional Appin. Ser. No. 61/970,700 entitled “System and Method for Vehicle Tracking System” filed on Mar. 26, 2014, the entirety of which is incorporated by reference herein.

### BACKGROUND

The current problems associated with moving business, personal and household goods and pets include lack of transparency, high costs, lack of transit information, difficulties in communication, and lack of real-time video. More specifically, goods moved between households and businesses using traditional processes are not monitored. The user is not able to view the goods or monitor their exact location, progress and timing of either the pickup or delivery. For very expensive luxury goods, art and dear personal possessions including pets, users cannot see the actual progress or real-time video of all items and only receive estimates that at times are grossly inaccurate.

Further deficiencies of the traditional process places consumers and businesses at the mercy of costs, decided by a mover after the move is completed. The cost model of the conventional process is inefficient and result in higher costs for the consumer. Under these processes, the items being moved for same day service are not given real-time progress to the consumer. Typically, the consumer is unable to see their item(s) at any point and often times only receives an estimate of the pickup or delivery time. The consumer is also unable to monitor the delivery progress in real-time or to change the delivery outcomes digitally.

In addition, the traditional process for moving requires voice contact between the consumer, transportation agents and dispatchers. There is no conventional process for alerting any of the parties associated with the process electronically, and in real-time. Finally, there is currently no software available for transporters to use that monitors their delivery service and also gives access to user to monitor the delivery progress as well. Furthermore, there are no systems available that are able to leverage both existing and third-party transportation assets in real-time for optimal scheduling and dispatching of delivery services.

### SUMMARY

Described herein are systems and methods for a vehicle delivery and tracking service. An exemplary method comprises receiving, via a software application, delivery task attributes over a network for delivering a physical load from a source to a destination, the delivery task attributes including at least source specifications, destination specifications and load attributes, automatically generating routing information for the physical load based on at least one of the delivery task attributes, automatically assigning a transportation resource to the delivery task based on at least one of the delivery task attributes and transportation resource attributes, transmitting a dispatch over the network to the assigned transportation resource, the dispatch including the routing information and at least one of the delivery task attributes, receiving delivery monitoring information during an execution of the delivery task, and transmitting a notification over the network to at least one of the assigned transportation resource and a user of the software application of the delivery monitoring information.

Also described herein is an exemplary server comprises a memory storing a plurality of rules, and a processor coupled to the memory. The processor is configured to perform actions that include receiving, via a software application, delivery task attributes over a network for delivering a physical load from a source to a destination, the delivery task attributes including at least source specifications, destination specifications and load attributes, generating routing information for the physical load based on at least one of the delivery task attributes, assigning a transportation resource to the delivery task based on at least one of the delivery task attributes and transportation resource attributes, transmitting a dispatch over the network to the assigned transportation resource, the dispatch including the routing information and at least one of the delivery task attributes, receiving delivery monitoring information during an execution of the delivery task, and transmitting a notification over the network to at least one of the assigned transportation resource and a user of the software application of the delivery monitoring information.

Further described herein is an exemplary non-transitory computer readable storage medium with an executable program stored thereon. The program instructs a processor to perform actions that include receiving delivery task attributes over a network for delivering a physical load from a source to a destination, the delivery task attributes including at least source specifications, destination specifications and load attributes, automatically generating routing information for the physical load based on at least one of the delivery task attributes, automatically assigning a transportation resource to the delivery task based on at least one of the delivery task attributes and transportation resource attributes, transmitting a dispatch over the network to the assigned transportation resource, the dispatch including the routing information and at least one of the delivery task attributes, receiving delivery monitoring information during an execution of the delivery task, and transmitting a notification over the network to at least one of the assigned transportation resource and a user of the software application of the delivery monitoring information.

### DESCRIPTION OF THE DRAWINGS

FIG. 1 shows an exemplary system for a vehicle delivery and tracking service according to an exemplary embodiment described herein.

FIG. 2 shows an exemplary method for a vehicle delivery and tracking service for the transportation of a load according to an exemplary embodiment described herein.

FIG. 3 shows an exemplary graphical user interface (“GUI”) for receiving user login information on a device running the software application according to an exemplary embodiment described herein.

FIG. 4 shows an exemplary GUI for order placement on a device running the software application according to an exemplary embodiment described herein.

FIG. 5 shows an exemplary GUI for goods/load information on a device running the software application according to an exemplary embodiment described herein.

FIG. 6 shows an exemplary GUI for listing goods/load itinerary on a device running the software application according to an exemplary embodiment described herein.

FIG. 7 shows an exemplary GUI detailing the assignment of delivery vehicles to the delivery order based on the availability according to an exemplary embodiment described herein.

FIG. 8 shows an exemplary GUI for vehicle tracking on a device running the software application according to an exemplary embodiment described herein.

FIG. 9 shows an exemplary GUI for an account summary on a device running the software application according to an exemplary embodiment described herein.

FIG. 10 shows an exemplary GUI of a website of a web browser operating the software application according to an exemplary embodiment described herein.

FIG. 11 shows an exemplary GUI of mobile devices running the software application according to an exemplary embodiment described herein.

FIG. 12 shows an exemplary flowchart for assigning resources and routes for a load using the vehicle delivery and tracking service according to an exemplary embodiment described herein.

### DETAILED DESCRIPTION

Described herein are systems and methods for a vehicle delivery and tracking service. The term vehicle or transportation resource (TR) may include, but is not limited to drones, manned or unmanned aircraft, trucks, shipping vessels, automobiles, etc. For instance, the exemplary embodiments relate to a process by which individuals can monitor, track, and be aware of their household goods, personal and business possessions and other transportable assets in real time as they are being moved in transit from one location to another during a specified time frame (e.g., for same day delivery service).

According to the exemplary embodiments, the methods and systems described herein may be performed using a software application operating on a digital computing device connected to a network, such as, but not limited to, a personal computer, a smart phone, a tablet, an e-reader, a smart watch, glasses, etc. According to an exemplary embodiment, the digital computing device may be a component within an intelligent transportation system or connected vehicle environment, such as, for example, a TR, a trailer, a storage container, etc., having an embedded computer device connected to a wireless network (e.g., Wifi, 3G, 4G/LTE, global positioning system (“GPS”), etc.) It may be noted that software application may refer to a program operation on the computing device, such as a mobile application. In addition, the software application may refer to a website of a web browser accessible to the user via the Internet.

The software application design allows the user to perform tasks relevant to the vehicle delivery and tracking service, such as: order a pickup, specify items, time and place for delivery, monitor the status/location of items in-transit, and “handing off” pickup and delivery for the user. Furthermore, the user may also track a series of TRs, such as components used for trucking (e.g., short haul, long haul, ship transportation, etc.) and components used for transport (e.g., trucks, containers, trailers, semi-trailers, tankers, containers on a truck, vessel, plane, etc.). Furthermore, exemplary TRs may also include autonomous cars, robots, drones, and other remotely controlled or self-piloted vehicles. The software application may also automatically calculate the price and time of the items based on the user's item list. As will be described in greater detail below, the software application may further utilize predictive analytics to determine a time of delivery, provide a receiver an estimate delivery time, and update the estimated delivery time as it is more precisely determined.

It may be noted that the term “user” used throughout this description may include a human user, such as an agent wishing to perform a transaction. Additionally, a “user” may also include non-human users, such as computing devices within a “machine-to-machine” (M2M) system. While traditional processes for moving require voice contact between the consumer, transportation agents and dispatchers, the exemplary embodiments described herein allow for the various stages of the processes to be performed electronically, as well as automatically. Therefore, the software application may employ M2M interactions to improve real-time information distribution, agent communications and facilitate the movement of goods.

As will be described in greater details below, the exemplary software application allows for a user to obtain quote prices for pickup and delivery service, to monitor the progress of a vehicle delivery, to monitor business and personal goods and/or pets while in transit, and to monitor overall the duration of the job at the consumer's convenience. Furthermore, the exemplary software application allows for the reporting and displaying of information to a user, as well as providing a M2M interface capable of updating related and third-party components within an M2M system. For instance, exemplary M2M interfaces may include application programming interfaces (APIs) or other communication mechanisms.

The exemplary embodiments described herein address problems associated with current moving businesses, specifically a lack of transparency, high cost, lack of transit information, difficulties in communication, and lack of real-time information such as video. Accordingly, the exemplary software application allows for goods moved between households and businesses using traditional processes to be monitored. The user may view the goods while monitoring their condition, exact location, progress and timing of either the pickup or delivery. For instance, real-time monitoring of goods, as well as monitoring the physical condition, security and integrity of goods such as dangerous or sensitive items, may include audio and/or video monitoring, image-based monitoring, location-based monitoring (e.g., GPS tracking) and/or environmental condition monitoring (e.g., temperature, humidity, etc.).

As discussed above, traditional moving and transportation processes place consumers and businesses at the mercy of costs decided by a transportation agent. Exemplary transportation agents may include movers, truckers, drivers, livery personnel, shippers, etc. The traditional cost model of these processes is inefficient and result in higher costs for the consumer. Exemplary embodiments described herein may cure these deficiencies through alternative processes, such as a reverse auction. Using a reverse auction process, the consumer may receive a plurality of bids from multiple transportation agents and accept a bid for the least amount, the best delivery schedule, etc. or any combination of criteria desired by the user or a transportation agent. It may be noted that these processes may be used even in cases where the price to the consumer is controlled by regulation. According to this scenario, the gross margin to the service may be increased. Furthermore, exemplary embodiments may utilize predictive analytics to predictively set pricing based on several factors, such as surges in demand, decreases in available assets for transportation, and any other factors that may influence the supply and demand of transportation services.

According to the exemplary embodiments described herein, predictive analytics may be used during scheduled transactions while the delivery of one or more loads is executed. The history of those orders, as well as their eventual execution and/or cancellation, may be recorded in a historical database. This information may then be used to build predictive models for certain ordering behaviors, such as how orders transition into to execution and how the executions of orders take place. The historical database may record any number of aspects of prior transactions, including the attributes of different orders, the dispatching history, the TRs used, type of loads, etc. Accordingly, these historical results may be used in whole or in part to predict events in similar transactions such as, but not limited to, which types of transactions may be cancelled, what types of loads are cancelled or cause issue in transportation, how many and what types of TRs will be needed at a future time, etc.

Furthermore, to cure the deficiencies of these conventional processes, the exemplary embodiments described herein allow users to monitor the transportation of goods through the exemplary software application operating on a computing device to see the items being shipped. In addition, the exemplary embodiments allow the user to ascertain all the costs associated with a transportation service before items are picked up and delivered, thereby ensuring competitive pricing. Furthermore, the exemplary embodiments may inform the user of the real-time location of the items during delivery, as well as a projected time frame for the items to arrive at the dropoff location.

As noted above, the exemplary embodiments may be performed over a software application executable on any digital computing device. The software application may be simple to use, allowing the user to ascertain costs, timing, vehicle location, and pickup and delivery information, e.g., for same day services. Accordingly, the scheduling of transportation services, including same day services, may be performed in real-time, and may therefore be executed as soon as possible or scheduled for a later time/date. The sending and receiving agents, as well as the monitoring features, may be processed by the software application through M2M interfaces. Reporting may be performed in real-time and any advertised delivery times may be updated predictively. Furthermore, pricing may be dynamic or fixed depending on agreements between parties (e.g., contracts). The dynamic pricing may be predictively estimated and adjusted in real-time based on any number of shipping factors.

Furthermore, it may be noted that the terms “goods” and “load” may be used interchangeably throughout this description to describe an asset to be transported. For instance, a load may be any physical object that needs to be transported from a source to a destination by a transportation resource (TR). Further examples of a load may include, but are not limited to cargo, boxes, packages, furniture, chemicals, liquids, food (e.g., catering in a box, dry or refrigerated), animals (e.g., livestock, pets, etc.), people (e.g., hospital patients, personnel, VIPs, etc.), construction and building supplies, etc.

Furthermore, a load may comprise multiple items and may have attributes characteristic of the load and/or how the load must be handled. Examples of such attributes are volume, weight, maximum heat exposure, minimum temperature, refrigeration requirements (e.g., for perishable food or biological items, etc.), flammable materials, liquid materials, handling requirements, security requirements, time constraints of load, etc.

Similar to loads having attributes, TRs have attributes and characteristics that may be used to determine if a certain TR is capable of transporting a load given the attributes and requirements. These TR attributes may include attributes that relate to size (volume capacity, etc.), climate control (temperature, lighting, humidity, etc.), etc. In addition, the TR attributes may identify a type of TR, such as a truck, car, plane, ship or other type of vehicle. Furthermore, these TR attribute may identify whether a resource may be dynamically scheduled and/or identify constraints related to such scheduling. For instance, a truck may be re-allocated in real-time, whereas a cargo ship may have limited flexibility to be scheduled dynamically in an instant.

According to the exemplary embodiments described herein, routes and routing information may relate to a series of waypoints on a travel route where one or more TRs are used to move a load from a current location to a destination location. It is possible that a route for a Load may include multiple pickups and dropoffs along an assigned route. In addition, a route may also have attributes that identify the type of route (e.g., a road, highway, street, alley, air route, shipping lane, etc.).

Furthermore, some routes may also have dynamic attributes updated in real-time, such as traffic congestion, closure, weather, tolls, time, distance, etc. Dynamic routing may be implemented to allow a given scheduled route, or an existing route to be modified to accommodate specific changes or exceptions, such as, for example, to add a further load. In this example, this further load may impact or otherwise modify the remaining route and/or segments based on the load's attributes, the routing and TR that comprise the current route.

A waypoint along a route may be described as a location defined by its position related to the Earth. For instance, a waypoint may include a street location, a navigation point on a flight plan, a transportation hub, a shipping yard, or other locations. Accordingly, waypoints may be described by their latitude and longitude on the Earth often as a set of GPS coordinates. Therefore, waypoints may be used to specify pickup, dropoff and intermediary exchange locations along an assigned route. An intermediary exchange may be where a load is moving from one TR to a different TR (e.g., from a small truck to a larger vehicle).

A segment may be described as a portion of an assigned route comprised of two or more contiguous waypoints. Furthermore, each segment may be either fixed or dynamic. A fixed segment is one where that portion of the route may not be dynamical altered or readily modified relative to the context of the overall route. For instance, this may include segments of a route not under the scheduling control of the exemplary software application. Alternatively, dynamic segments may be segments of a route that can be altered based on any available changes in assigned routing and/or TRs.

During the normal course of transporting a load, automated notifications of impending events may be sent to various interested users, such as clients and drivers. For example, one or more users may be automatically notified that an impending pickup or a delivery is about to take place. These notifications may also include delivery exceptions, status information at defined intervals or waypoints along a route, changes in routes. Furthermore, automated notifications may take the form of electronic messages to another electronic system such as, but not limited to, an email message, a text (e.g., a short message service (SMS) message, a multimedia messaging service (MMS) message, a group broadcast message, etc.), a phone call, a social media broadcast (e.g., a tweet), an if-this-then-that or “IFTTT” conditionally triggered message, or any other electronic or non-electronic means of notification.

Exemplary TRs may be monitored in real-time and automatically notified of any exceptions with the capability for human intervention. Examples may include a TR that is no longer available (e.g., the vehicle broke down, out of gas, needs maintenance, etc.), a route no longer available (e.g., construction detours, weather interruptions, time delays, etc.). In addition, TRs may not be permitted to use assigned routes due to transient conditions (e.g., weather has closed road, travel restrictions define by police, etc.).

The exemplary method and systems described herein may implement load exception handling during any instance where a load constraint has been met or violated, or wherein a constraint is being approached. In addition, an automated message may be created by the system to notify agents that may take intervening action to rectify the situation. An exception agent may be a human user (e.g., a driver, a human dispatcher, etc.) or another automated system component. Accordingly, exception handling may require routing and/or TR modification to a route in real-time in order to potentially remedy the situation. These exceptions may be related to environmental circumstances or a security event that may require intervention to remedy as well as further action, such as, but not limited to, notifying the police, authorities, or fire department, requesting mechanical or refrigeration repair, etc.

According to some embodiments, it may be the case that waypoints on the route have specific time constraints associated with them. These time constraints may include specific times for departure and arrival at designated waypoints or time spans within which segments of the route must be completed. Based on these time constraints, the systems and method may utilize time shifting to coordinate multiple segments of a route with assigned TRs. Furthermore, location shifting may be implemented during an instance where an agent outside of the system is willing to move a load to a specified location. Accordingly, this may be done so that the load may be aggregated with other loads and/or to more easily accommodate a pickup by a TR. Both time shifting and load shifting may provide more efficient use of resources, as well as an opportunity for discounts on services.

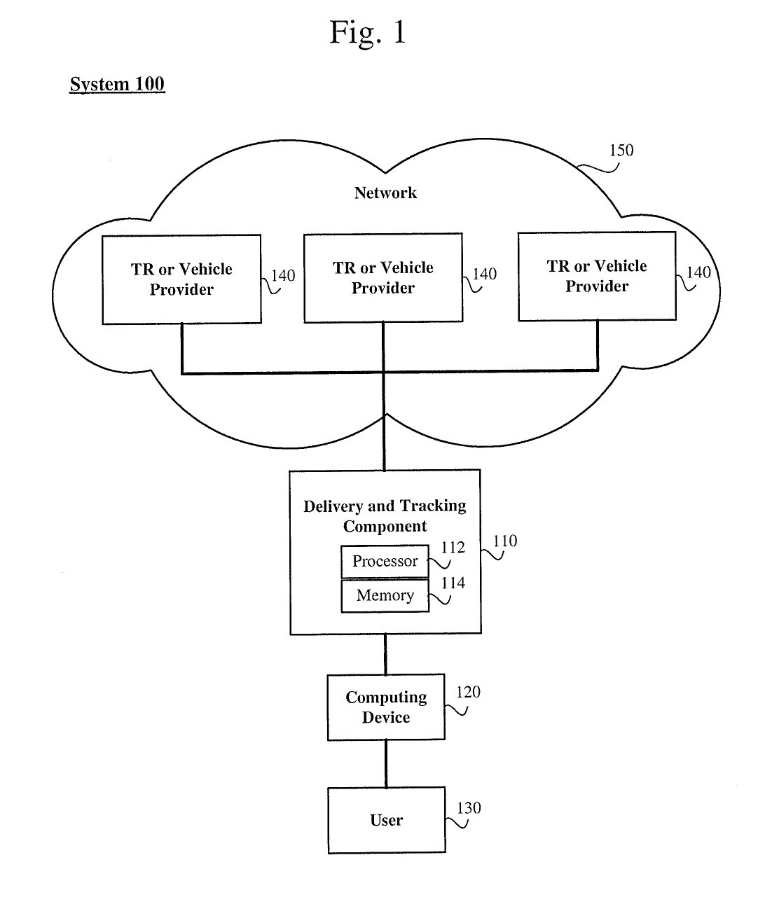

FIG. 1 shows an exemplary system 100 for a vehicle delivery and tracking service according to an exemplary embodiment described herein. The system 100 may include a delivery and tracking component 110 for interfacing with at least one user 130 and a plurality of vehicle providers 140 over a network 150. The exemplary delivery and tracking component 110 may include a processor 112 and a memory 114 for storing instructions executable by the processor 112, and may act as a server servicing the execution of a delivery task. Accordingly, the delivery and tracking component 110 may perform any of the steps and processes related to, but not limited to, receiving delivery attributes, generating predictive models and pricing models, routing and asset coordination, managing real-time information, updating routing and asset coordination, user notifications, executing and completing delivery task, etc.

As noted above, the software application operating on a computing device 120 of the user 130 may allow the user 130 to discover all the information about same day deliveries, such as the location and movement of the delivery vehicle(s) transporting the goods, mapping, projected times of arrivals, driver information, driver/vehicle provider ratings, costs, video surveillance of the goods and vehicle, etc. Accordingly, the exemplary embodiments described herein offer the user 130 the unique ability to monitor and track daily deliveries of goods moved by a third-party (e.g., vehicle providers) through delivery and tracking component 110 operating on any digital computing device 120 connected to a network 150 (e.g., the Internet).

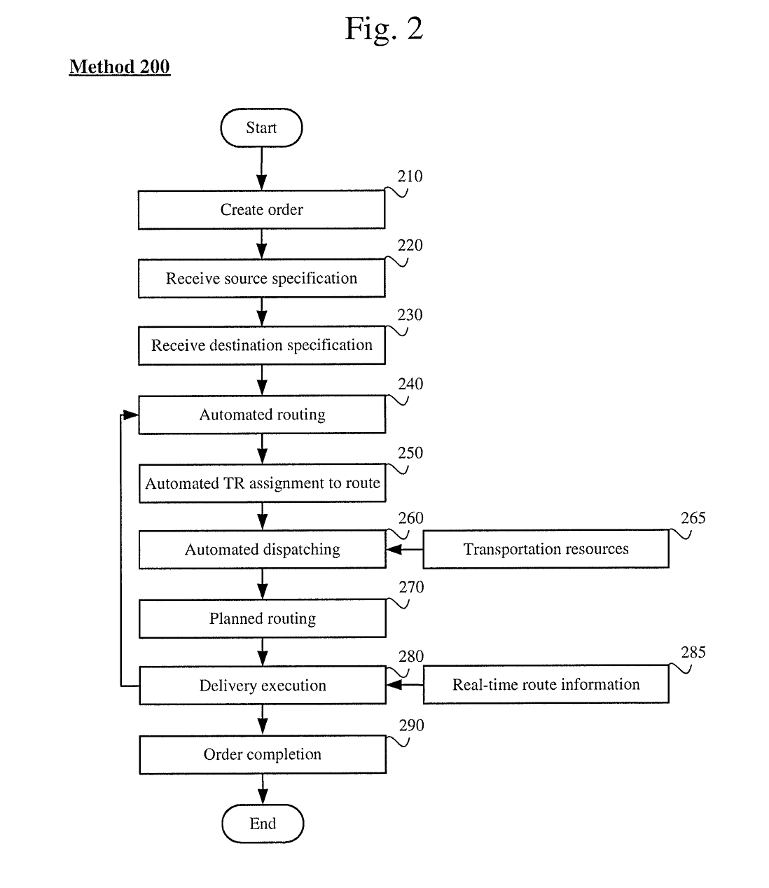

FIG. 2 shows an exemplary method 200 for a vehicle delivery and tracking service for the transportation of a load according to an exemplary embodiment described herein. The exemplary steps of the method 200, as well as any notifications and messaging related to the method 200, may be performed electronically through one or more software applications, such as delivery and tracking component 110 of FIG. 1. A human user of the system 100 through may initiate the steps through interaction with the computing device 120 (e.g., a mobile device). Additionally, or alternatively, any number of these steps may be fully automated, wherein a software agent performs the steps and creates a notification or message based on criteria determined within the software application.

In step 210 of the method 200, the user 130 or an automated system creates an order to move a load.

In step 220 of the method 200, source specifications are received that identify the location where the load is to be picked up. In addition, the source specifications may also identify particular attributes and/or characteristics of the load. The source specifications may also be accompanied by information identifying any time constraints for the pickup of the load and/or any other constraints relevant to the pickup.

In step 230 of the method 200, destination specifications may be received that identify the location to which the load is to be delivered. Similar to the source specifications, the destination specifications may also identify particular attributes and/or characteristics of the load. The destination specifications may also be accompanied by information identifying any time constraints for the delivery of the load and/or any other constraints relevant to the delivery.

In step 240 of the method 200, the source and destination specifications from steps 220 and 230 may be used for automated determination and scheduling of one or more transportation routes for the load. More than one routing option may be calculated and an exemplary route may be comprised of a plurality of segments. Accordingly, each of the time constraints for delivery and/or pickup may be taken, into consideration across all of the segments of the route. Furthermore, the automated route determination and scheduling may also provide an estimated cost calculation for each of the routing options.

In step 250 of the method 200, a transportation resource (“TR”) may be assigned to the scheduled delivery of the load. It may be noted that multiple TRs may be assigned to a load, and an assignment of one or more resources may be performed any time prior to the completion of the delivery of the load. For instance, different TRs may be assigned to different segments of the route. Accordingly, one or more TRs may be assigned as the most appropriate TR for the delivery task, based on a plurality of available TRs.

Furthermore, the assignment of TRs may be adjusted dynamically based on any changes to the delivery process and/or environment. Due to exceptions of a route or a segment, TRs may be scheduled or rescheduled as needed as part of rectifying these situations (e.g., TR failure, loss of a route, etc.). Furthermore, as discussed above, the assignment of the TRs in step 250 may also utilize a reverse auction to determine the most suitable TR to perform the delivery task at the lowest cost. In addition, cost estimates may be refined during the assignment process.

In step 260 of the method 200, the one or more TRs may be dispatched to the delivery route, including any segments of the route for the delivery task. Dispatching may be described as the assignment and scheduling of one or more loads with one or more appropriate TRs along one or more routes for delivery. Loads may be automatically scheduled based on the optimal matching of attributes while satisfying the pickup and delivery criteria, source specifications, destination specifications, minimizing the number of assigned TR(s), overall costs, etc.

According to the exemplary embodiments of the method 200, automated dispatching may be used for the determination and assignment of a route. More specifically, automated dispatching may include assigning waypoints to move a load from a source pickup location to a destination delivery location. Furthermore, each of the assigned routes and waypoints may further include an assignment of one or more TRs. The TR(s) and route(s) may then dynamically change in real-time based on factors, such as TR availability, traffic congestion, weather conditions, etc. While the scheduling and dispatching over method 200 may be automated, manual intervention may override and alter any of the dispatched segments and assignments in real-time. Thus, there may be both fixed and dynamic segments of a scheduled route.

In step 265 of the method 200, while the TRs are being dispatched in step 260, the availability of appropriateness of resources is ascertained. Specifically, factors may include attributes of the TR(s), location of the resources and current scheduled use of the resources. Accordingly, if a current capacity of the system is insufficient or inappropriate for the attributes specified, additional TRs may be requested from external parties, such as from TR partners, through renting, leasing, purchasing, etc.

As noted above, the exemplary method 200 may provide automated notifications to all parties involved as each of the steps are performed during the delivery task. These parties may include, but are not limited to, the sender of the load, the receiver of the load, the TRs and TR partners that coordinate delivery of the load across all segments of the route, etc. Furthermore, each of the parties involve may elect to subscribe or ignore any or all of the automated notifications.

In step 270 of the method 200, any existing routes previously assigned to a TR may be implemented. For instance, a TR assigned to a delivery task having sufficient time to travel to the source specified in step 220 may be assigned to an existing route. The output of the new diagram shows a TR, Route and Load assigned. Planned routing may be described as the output after the automated routing and automated dispatching. Prior to the execution of the delivery task, the planned route may represent the current route, the assigned TRs and the load of the delivery to be executed. The planned route may then be recalculated as any more optimal TRs become available prior to, or during, the execution of the delivery task.

Accordingly, step 270 may be performed when the current TR, route and load are acceptable for execution. Once the execution has begun, real-time information may augment the models predicting the execution of the delivery task, such as movement along the route of the TR, TR factors (e.g., fuel consumption, speed, maintenance fitness, etc.), weather, route conditions (e.g., traffic, closures, etc.).

Following the planned routing in step 270, the execution of the delivery process may be performed in step 280. While the delivery is executed in step 280, in step 285 real-time information of the delivery performance may be monitored, along with external factors that may affect the delivery process. Thus, the delivery execution of step 280 may cause perturbations to the initially planned route. As the real-time factors are monitored during the planned route, the exemplary system may determine that the planned routing is no longer optimal or that a failure of the TR is imminent. In either of these cases, the system may return to the automated routing in step 240 to determine if the current route is still optimal, or if the current route needs to be modified based on this new input. At any time during the execution, exceptions and changes to the assigned route and/or TRs may be processed based on changes to delivery requirements or external factors such as weather, traffic conditions, etc.

To facilitate these exceptions and changes during the execution of the delivery, the method 200 may return to step 240 to recalculate a new automated route from the current position of the TR(s) based on the new circumstances. Accordingly, using the new automated route information, the method 200 may continue to the automated dispatcher in steps 250-255 to determine if TR changes are required. The system may then transition through automated dispatching in step 260 to determine if all the TRs are still appropriate for all the segments of the route based on any potential modifications to the route. After this step, the system may once again be in a state where the route, TR and load are all known to be optimal, and the planned route state may be entered in step 270 and execution continues in step 280. In real-time, the transitions between these operations occur in the background during the execution of the deliver task. Each iteration of new route information may produce a new planned route in step 270 that continues during the execution of the delivery in step 280. Thus, as the delivery task is executed, steps 240-270 may constantly be reiterated to accommodate any changes or exceptions in the delivery task.

In addition, various parties may provide user input during the execution of the delivery task. For instance, the sender may identify that the delivery process has begun, the TR may identify that the delivery process has begun, automated status messages may begin to be published by the TR and the system, subscriptions to these messages may be managed, and changes and exceptions to the delivery task may be published for monitoring by interested parties. Therefore, any user 130 monitoring the delivery and/or subscribing to the messages may be informed of weather conditions, traffic incidents, required changes to the TRs and/or route, etc.

In step 285 of the method 200, during the execution of the delivery task in step 280, real-time factors that affect the delivery of the load on its assigned route may be monitored and used to further optimize the delivery. Examples of these real-time factors may include, but are not limited to, traffic information (e.g., alerts, congestion, incidents, etc.) along the route, the availability of segments of the route, changes to the availability of one or more TRs, any other changes or exceptions as discussed above, etc.

In step 290 of the method 200, the delivery of the load may be completed and notifications of the completion may be sent to each of the interested parties. For instance, notice of the delivery completion may include an identification from the TR that the delivery is complete, an identification from the receiver of the load that the delivery has been completed successfully, a survey and/or ranking request for any of the parties (senders, receivers, TRs, etc.) for assessing satisfaction with other party members, as well as with the overall process, etc.

It should be noted that each of the steps performed during the method 200, the parameters for planning and executing the delivery, as well as the exception factors (e.g., traffic) may be logged into database, such as the memory 114 of the delivery and tracking component 110 of system 100. The information stored in the database may then be used to build predictive models to determine future behavior of the system 100.

Furthermore, method 200 is an example of one embodiment for performing a vehicle delivery and tracking service. Additional embodiments may include additional steps or may eliminate certain steps. Additional steps may include receiving a description of an item to be delivered, generating a delivery cost based on at least one of the source specifications, the destination specifications and/or the description of the item, receiving an availability of each of a plurality of TRs, receiving location of the TR(s) after assigning the first delivery vehicle to the delivery order, wherein the location is determined from a GPS, updating and transmitting the location of the TRs to the user 130 until completion of the delivery task.

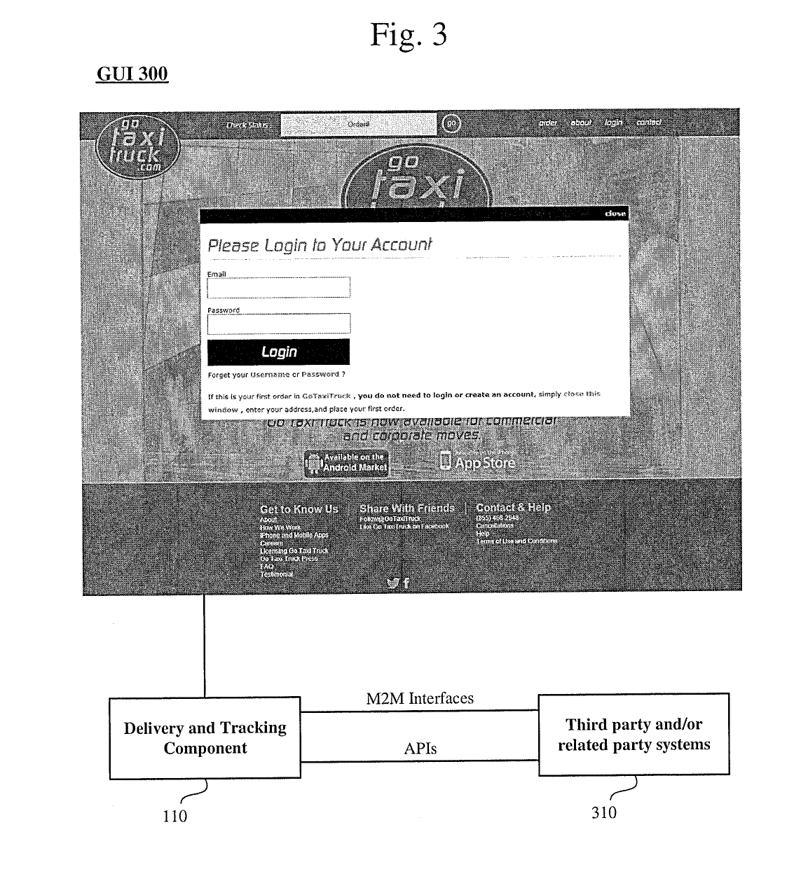

FIG. 3 shows an exemplary graphical user interface (“GUI”) 300 for receiving user login information on a device running the software application according to an exemplary embodiment described herein. The GUI 300 may be provided from the exemplary delivery and tracking component 110 and is displayable to the user 130. From this GUI 300, the user 130 may provide login credentials to access their accounts. Furthermore, the delivery and tracking component 110 may be in communication with various third-party systems and/or related party systems 310 via M2M interfaces and APIs. It may be noted that the GUIs illustrated within the figures are merely exemplary figures. Those skilled in the art will understand that any variations to the design and layout may remain within the overall scope of this invention.

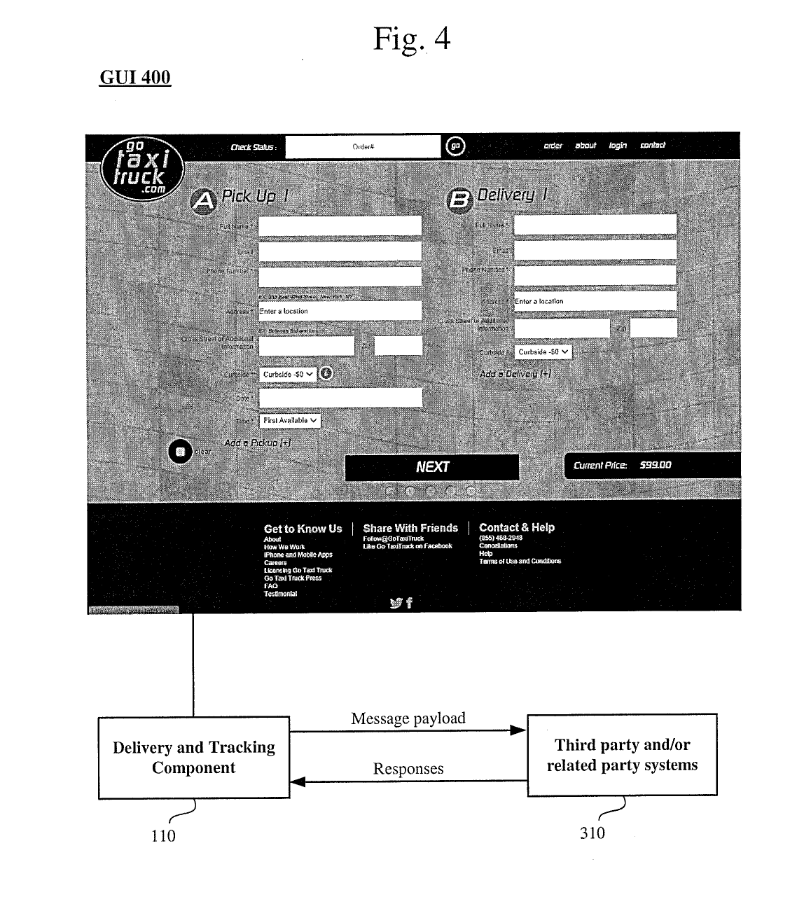

FIG. 4 shows an exemplary GUI 400 for order placement on a device running the software application according to an exemplary embodiment described herein. From this GUI 400, the user 130 may provide all information relevant to the delivery of the load or goods in a message payload from the delivery and tracking component 110 to the third-party and/or related party systems 310. The information in the message payload may include delivery date and time, names, addresses, phone numbers at both the origin location and the destination location, a current price, etc. Accordingly, this information identifying all of the parameters of a delivery task may be controlled and automated by the system. Furthermore, the delivery and tracking component 110 may receive response messages from the third-party/related parties 310 including updated delivery information, as well as acknowledgments of receipt of the message payload. Those skilled in the art will understand that any number of additional details may be provided by the user 130 via this GUI 400.

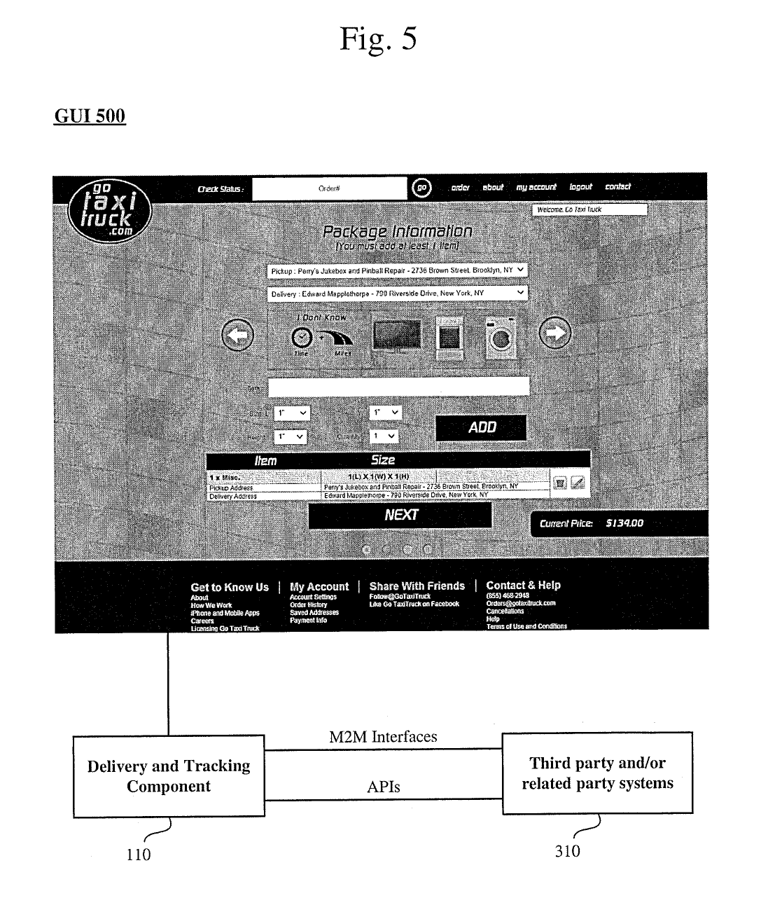

FIG. 5 shows an exemplary GUI 500 for load information on a device running the software application according to an exemplary embodiment described herein. From this GUI 500, the user 130 may provide detailed information related to the load being delivered. For instance, the user 130 may provide information such as quantities, sizes, weights, dimensions, descriptions, etc. Furthermore, through the use of the exemplary software application, the user 130 may perform numerous actions without needing to talk to or interact with a customer representative of either the delivery service or vehicle provide. Examples of actions may include requesting upfront pricing, make/view/modify an order, cancel reservations, select pickup/dropoff locations, enter their personal and billing details, confirm the booking, etc.

It should be noted that while the delivery and tracking component 110 may allow for the user 130 to manually enter specifications for a delivery task, alternative embodiments allow for this information to be received automatically. Specifically, in the case of system automation, the load being shipped may be automatically identified by the system 100. For instance, the load may identify (in an automated manner) the types of attributes of a shipping resource required to transport the load. These attributes may include an estimated size and weight of the load, refrigeration requirements, the type of load (e.g., liquid, hazardous material, animals, etc.). Accordingly, based on these attributes, a shipping resource may be explicitly or implicitly determined automatically. Furthermore, the attributes of the load may further affect the pricing and availability of the TRs through the use of pricing and asset allocation models.

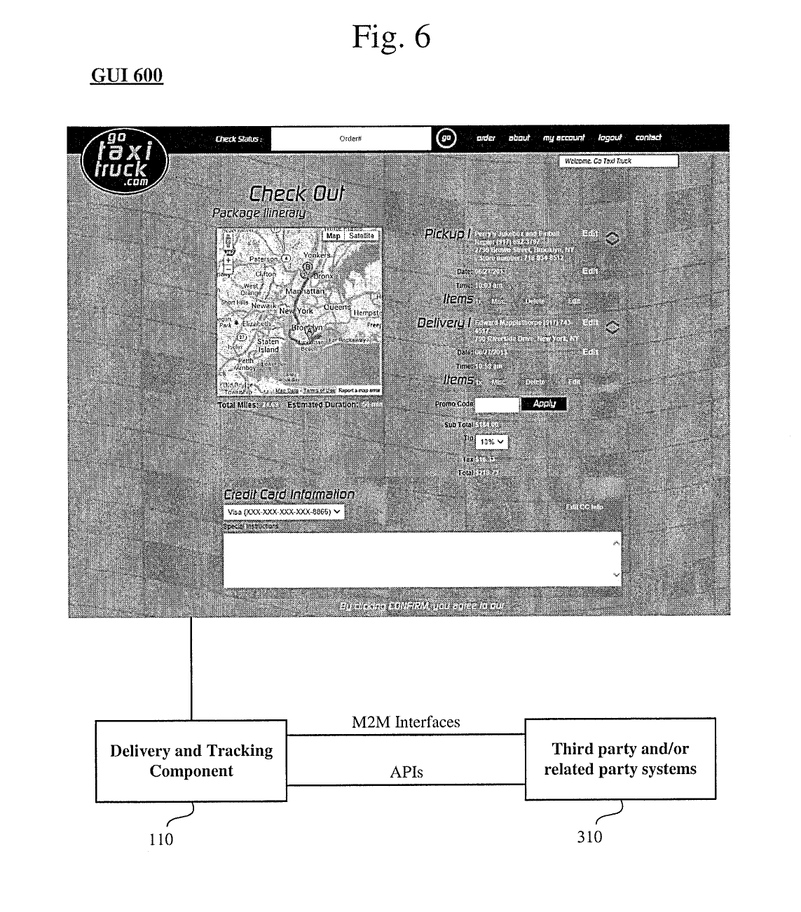

FIG. 6 shows an exemplary GUI 600 for listing load itinerary on a device running the software application according to an exemplary embodiment described herein. During the delivery order preparation process, the user 130 may check out of the software application with a “load itinerary.” The load itinerary may include confirmation information describing pickup and delivery locations, phone numbers, type of items to move, total cost of the haul, the payment information of the user 130 (e.g., customer credit card information), any special instructions, etc.

Once again, while the delivery and tracking component 110 may allow for the user 130 to manually enter the load itinerary of a delivery task, alternative embodiments allow for this information to be received automatically. In other words, an automatically updated itinerary may be presented to the user 130 via the GUI 600, as well as presented to the third/related parties 310 via the M2M interface. In the case of the M2M communications or the GUI 600 displayed to the user 130, items in the load itinerary may have critical timing components (e.g., spoiling of goods, rendezvous with another shipping resource, etc.). Accordingly, the GUI 600 may represent an updated “snapshot” of the ongoing delivery task, as well as identifying a specific stage of the task. The delivery times and pricing information may be dynamically updated within this snapshot, along with other delivery parameters (e.g., temperature, environmental factors, traffic conditions, vehicle speed/position, etc.).

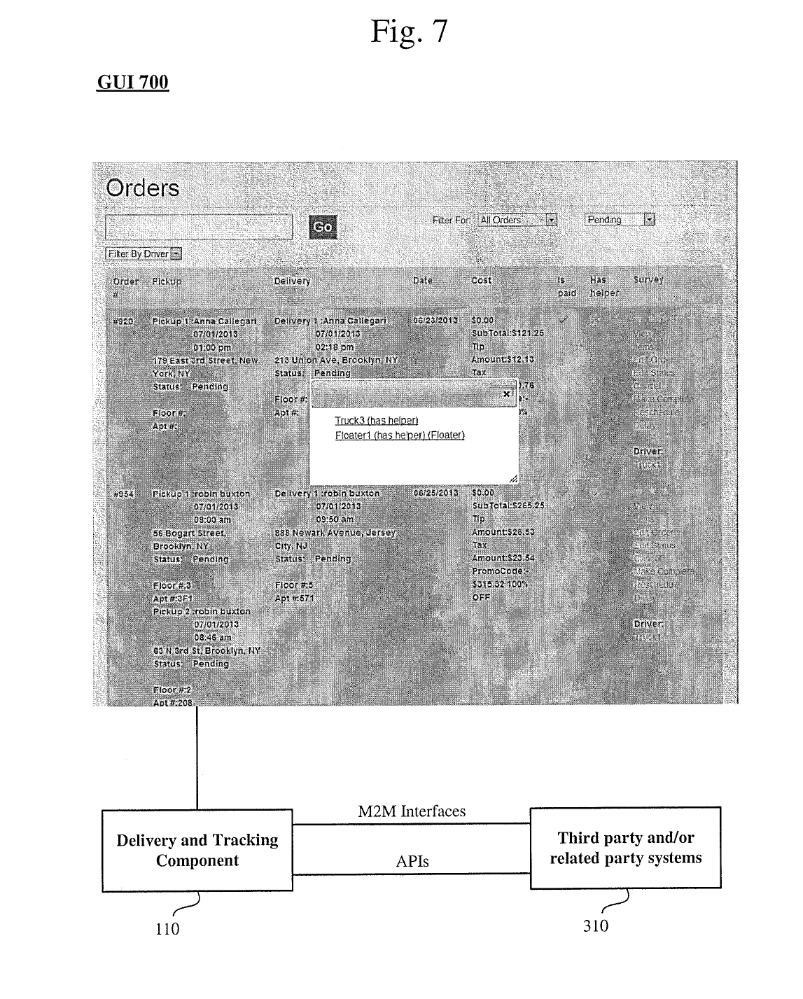

FIG. 7 shows an exemplary GUI 700 detailing the assignment of TRs or delivery vehicles to the delivery order based on the availability according to an exemplary embodiment described herein. From this GUI 700, the delivery and tracking component of the system may list order information to vehicle providers related to any open orders. Order information may include, for instance, order numbers, origin/destination addresses, time and date, delivery cost, available personnel, etc. In addition, the GUI 700 may receive and display availability information for each of a plurality of delivery vehicles from all of the vehicle providers within the network. Furthermore, the delivery and tracking component 110 may narrow the listing of vehicle providers based on a predetermined proximity to the origin location. Based on the availability information, the delivery and tracking component 110 may automatically assign a delivery vehicle to an open delivery order based on the availability of the first delivery vehicle and delivery cost of the order.

According to the exemplary embodiments, the selection of the asset used in the delivery process as well as the coordination of which assets to perform the delivery may be automatically selected based on the attributes of the load and the attributes of the shipping assets available. Furthermore, dynamic pricing, time and location shifting of the loads can also be included to optimize both the delivery of the asset and load optimization. While the process may be automated, there may be instances that allow for human user intervention. For instance, a dispatcher might be notified if something exceptional occurred like a vehicle fire or when assets are determined to be missing. However, the majority of the steps related to assigning TRs to a delivery task may be automated based on delivery specifications.

Accordingly, the exemplary systems and methods described herein employ sophisticated and proprietary algorithms to automatically determine the next best vehicle to pick up the load. The exemplary software allows for many variables, such as but, not limited to where the vehicle is located, any other scheduled pickups, space in the vehicle, user time requirements, traffic to delivery location, miles to delivery location, time to deliver and pickup the items, location of other available vehicles, etc. In addition, the software may compute a time calculation to determine which vehicle should be assigned to a specific pickup and/or delivery. Additionally, the system and method for matching a load to one or more TR assets will be described in greater detail below.

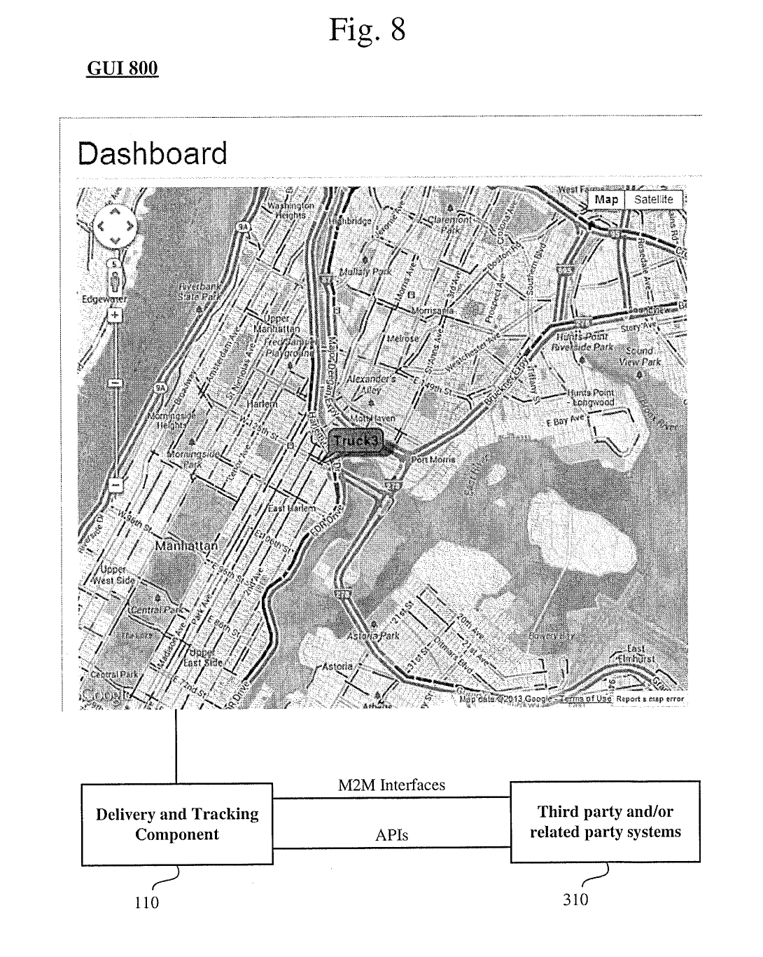

FIG. 8 shows an exemplary GUI 800 for vehicle tracking on a device running the software application according to an exemplary embodiment described herein. As detailed above, the software application provides the user 130 with the ability to login to their account and monitor the real-time progress of the pickup and delivery of their load by the assigned vehicle and driver. According to one embodiment, the location of the vehicle may be determined from a tracking system (e.g., GPS) within the vehicle. In addition, vehicle tracking may also include positional attributes and load attributes, when possible.

Furthermore, when the transaction includes M2M-connected agents (e.g., third/related parties 310), a snapshot of the vehicle and delivery status may include all of the static and dynamic attributes of the transaction and the payload, as well as any itinerary updates. Accordingly, status snapshots may be generated and transmitted at a fixed or dynamic frequency based on any requirements, attributes of the load, status or environmental conditions, exceptional events, changes to itinerary, etc.

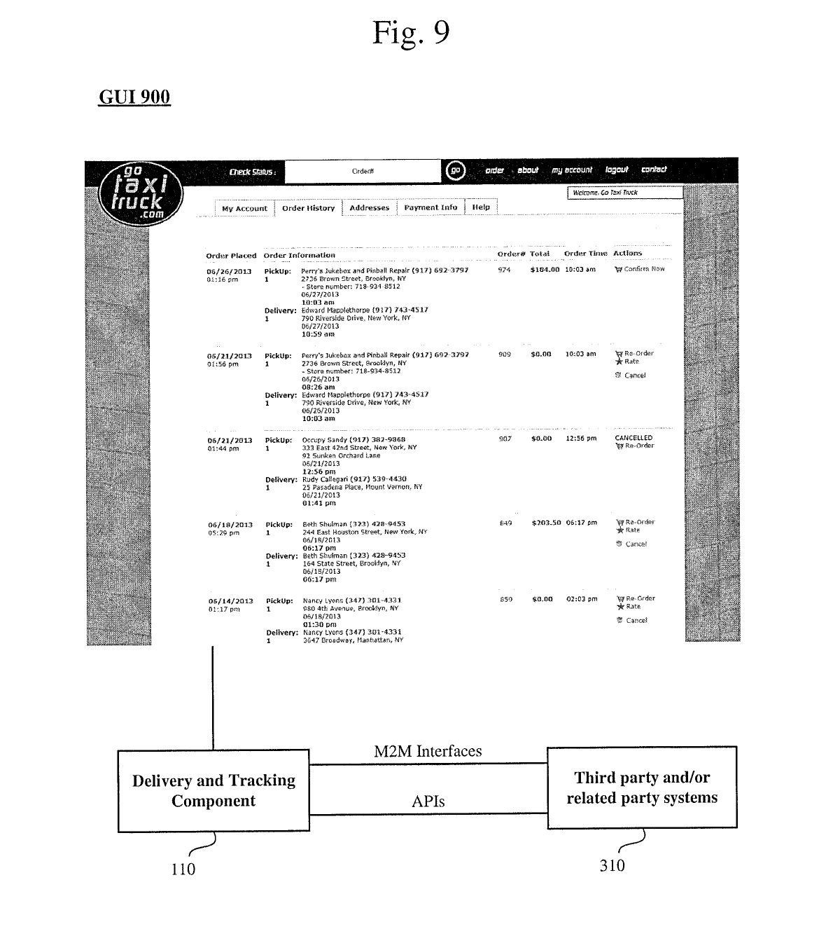

FIG. 9 shows an exemplary GUI 900 for an account summary on a device running the software application according to an exemplary embodiment described herein. From this GUI 900, existing users may monitor their account over the software application (e.g., on a website, via a mobile application, etc.). The account summary may maintain a history of all the orders placed by each of the users 130. Furthermore, the users 130 may also have the ability to re-order a job from the past without having to re-enter the order information. As discussed above, the information from this GUI 900, as well as any other GUI described herein may be transmitted to both human users and automated M2M agents. Accordingly, the information from GUI 900 may allow for both a human user and a M2M component to monitor and report on account summary information.

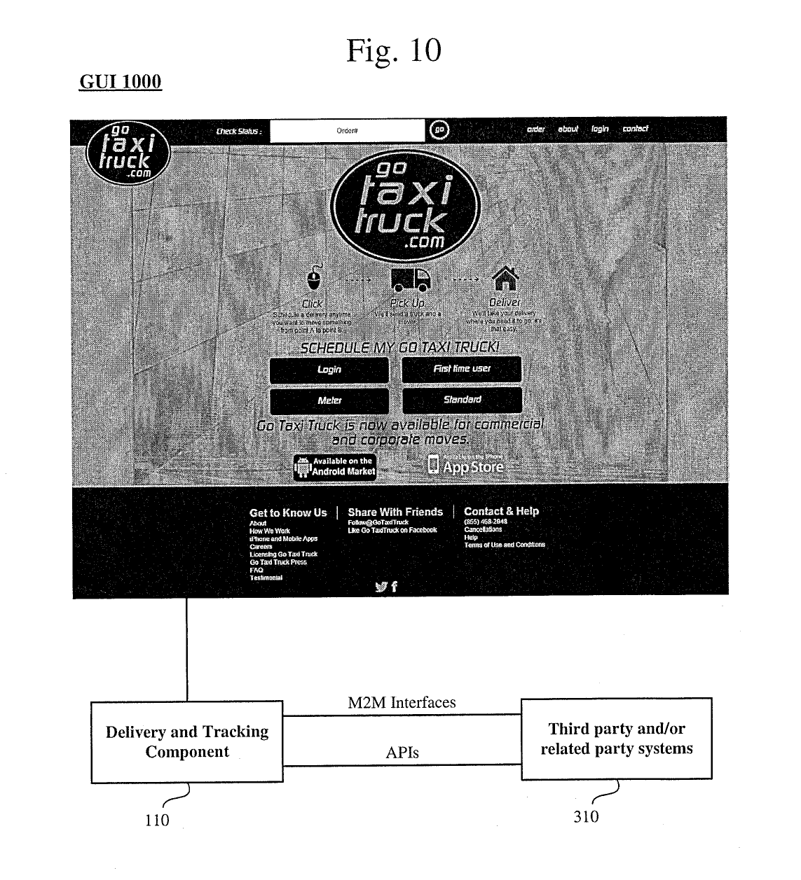

FIG. 10 shows an exemplary GUI 1000 of a website of a web browser operating the software application according to an exemplary embodiment described herein. From this website GUI 1000, new users may create accounts, existing users may login, orders may be tracked by order numbers, and various additional information may be made available to both existing and perspective customers. Accordingly, human interaction may be provided via a website displaying the GUI 1000. Those skilled in the art will understand that the received information may be made available to third parties and related parties 310 via web services APIs.

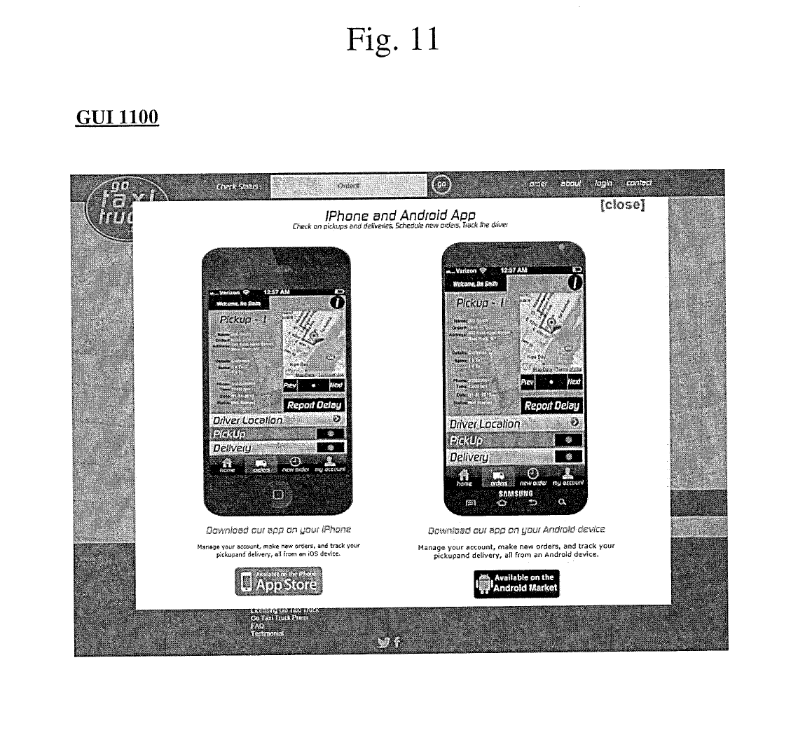

FIG. 11 shows an exemplary GUI 1100 of mobile devices running the software application according to an exemplary embodiment described herein. As noted above, a smartphone may be an example of a computing device 120 that may support the software application featuring the delivery and tracking component 110. In addition, an on-board telephone/multimedia vehicle system connected to a network (e.g., a wi-fi network, a cellular network, such as a 4G LTE network, etc.). From the GUI 1100 of the mobile application, the user 130 may perform similar, if not all, of the actions available to the user 130 over the website interface. In addition, the smartphone device and/or connected vehicle system may be an example of a computing device 120 that could serve as a component in a transportation asset (e.g., on a vehicle, on a shipping container, etc), thereby providing up-to-date information of an executing delivery task. Those skilled in the art will understand that the mobile application may be made available to the mobile device of the user 130 via an application store/marketplace.

The advantages of the exemplary systems and methods described herein may include: lower costs to the user 130 with greater transparency of timing, costs and delivery results, lower costs to the vehicle providers (e.g., moving and/or transport companies) that allows the vehicle providers to monitor costs, drivers, driver ratings, locations of trucks, transport vehicles and packages. Furthermore, the ease of use for both users 130 and vehicle providers allows for greater productivity and efficiency. The software application provides the solution for the deliveries of a load that may be accomplished on the same day as the placement of the delivery order. Additionally, for valuable and important business items, users 130 may desire transparency for real-time data on any digital computing device.

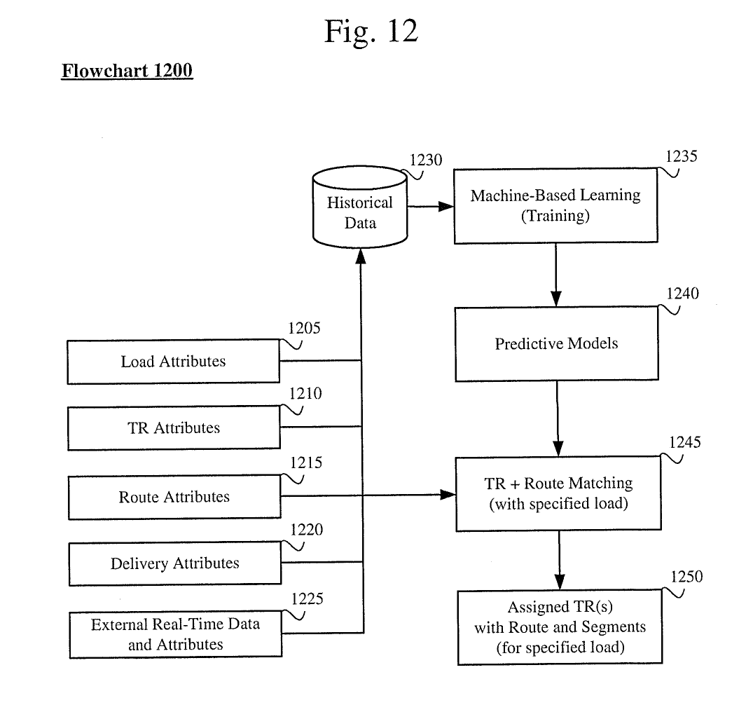

FIG. 12 shows an exemplary flowchart 1200 for assigning resources and routes for a load using the vehicle delivery and tracking service according to an exemplary embodiment described herein. The flowchart 1200 may include receiving a plurality of attributes specific to a delivery task. For instance, the received attributes may include, for example, load attributes 1205, TR attributes 1210, route attributes 1215, delivery attributes 1220, external real-time data with attributes 1225, etc. Each of the various attributes may be received through a software application, such as the delivery and tracking component 110 of FIG. 1. While FIG. 12 depicts five different attributes for the specific delivery task, one skilled in the art would understand that any number of additional attributes may be taken into consideration.

Once these attributes have been received the flowchart 1200 may advance to a historical database 1230. According to one embodiment, the historical database 1230 may be stored within a memory of the exemplary software application, such as the memory 114 of the delivery and tracking component 110 of FIG. 1. As noted above, the history of any previous orders may be recorded in this historical database 1230. The historical database 1230 may record any number of aspects of prior transactions, including the attributes of different orders, the dispatching history, the TRs used, type of loads, etc.

This information, along with the eventual execution and/or cancellation of delivery tasks, may then be used to train the system using machine-based learning 1235. Through the use of technologies such as Pattern Analysis and Machine Intelligence (PAMI), the information from the historical database 1230, as well as current task attributes, may be monitored and recorded relating to attributes of the loads to be delivered, the TRs to execute the deliveries and particulars of the routes employed in those deliveries.

Based on the historical behavior recorded in the historical database 1230, machine-based learning technology 1235 may be applied to build predictive models 1240 of the future demands that will be placed on the system. For instance, future demands may be predicted over next hour, day, week, month, etc. Furthermore, predictive models 1240 may be built for certain ordering behavior, such as how orders transition to execution and how the executions of orders take place. Accordingly, these historical results may be used in whole or in part to predict events in similar transactions such as, but not limited to, which types of transactions may be cancelled, what types of loads are cancelled or cause issues in transportation, how many and what types of TRs will be needed at a future time, etc.

Accordingly, predictive models 1240 may be built to identify any number of patterns. For instance, these patterns may include identifying: which attributes of loads are most often associated with delays, exceptions, cancellation or rescheduling; which attributes of TRs are most often associated with delays, exceptions, cancellation or rescheduling; which attributes of Routes are most often associated with delays, exceptions, cancellation or rescheduling; which combinations of the above attributes combine to affect delays, exceptions, cancellation or rescheduling; etc. Thus, with the use of the predictive models 1240, users may use the predictions to project and anticipate capacity and overcapacity such as to maximize the load throughput of the system while simultaneously maximizing the utilization of the available TR capacity.

According to the further exemplary embodiments, additional patterns on dynamic pricing may also be based on predictive modeling. Specifically, dynamic pricing may be affected by a number of factors, including the attributes of the load, the TR attributes required for the Loads transportation and the route required to complete the delivery combined with the availability of appropriate TRs around the desired time of the delivery. The attributes of the load may determine the minimum requirements for the attributes of the TR that is required to transport the load. These attributes may include size, weight, refrigeration requirements and other environment factors, security, video monitoring, etc. In addition, the TR may be selected to meet the requirements for the route, such as, but not limited to trucks for roads, boats for waterways, planes for air routes, etc. Furthermore, the minimum attributes for the TRs that are implied by the load may create sets of TRs from different TR classes that are capable of transporting a load along any route. Therefore, any TR that meets or exceeds the load and route attributes necessary to transport a load may be used. For example, a refrigerated truck is capable of adequately transporting a load that does not require refrigeration assuming it meets the other requirements for the load.

The union of these sets of TRs may generate a superset of TRs including all vehicles capable of transporting a load across a specified route. The availability of TRs within each TR class may be predicted for the time delivery window of the load. Each TR may have a typical operating cost per mile given a specific Load. Accordingly, this operating cost, as well as any other service margins, may provide a base rate charge to provide the TR to a delivery task. Additionally, a variable component that scales to the availability of a TR class may be applied to the price as a surcharge or discount.

Additional embodiments of the system may allow for estimating a price rate based on mileage and/or time, a type of the load, the route assigned, the class of TR to be used to transport the load, etc. Since TR availability may be affected in real-time, a more cost effective TR that meets all the load attributes may become available to deliver the load at anytime before the delivery, and thus may then become part of the superset of TRs available for a delivery task. If a route is comprised of multiple segments and multiple TRs are to be assigned for a delivery task, this real-time calculation may be performed for each segment. The aggregate of all the segments may become the overall price estimate or price for the route.

The exemplary system described herein may present a price estimate of the overall delivery process using a mileage and/or time rate calculated based on predictions for the routes, TR and time to execute the deliver withstanding the historical behavior of similar deliveries in the past and estimated conditions at the time of the future deliver. Since the route and actual TR assigned to the delivery may vary in real-time, the rates and surcharges/discounts applied in the estimating process may be replaced by the actual mileages/times based on the route, TR and time actually taken to deliver the load upon actual delivery. Furthermore, any surcharges and/or discounts factored in the calculation may vary as demand decreases or increases for a specific TR class at the time of delivery.

In addition, the mileage/time charge scaling factors may be scaled to encourage client or TR supplier behavior on the system. For instance, higher scaling factors may increase the price to the client to decrease demand for a specific class of TR and encourage third-party TR to increase supply of desired TRs. Also, the scaling factors may be decreased if the client is willing to time shift a load to a time when a TR is already in the vicinity of a pickup point and has space for the load or when there are more TRs available at that alternate time. In these cases, the pricing may be scaled based on availability factors of TRs that are appropriate to move a load for a delivery that is acceptable to the user.

It is noted that the exemplary system may use the predicted estimates of the price to quote or guarantee the charges calculated based on the predicted route and TR class. Additionally or alternatively, the exemplary system may assign a flat rate charge for the delivery of the load regardless of the time or mileage actually taken to complete the delivery.

With regards to the factors that may require intervention within the shipping process such as damage to goods, spoilage, etc., the exemplary system may take additional steps during a delivery task. For instance, when a load has attributes specifying that the TR must provide environmental controls to prevent spoilage, the TR may send an automated message to the system if those conditions are breached and/or if they approach a threshold specified by the system. Once the message has been received, the system may respond to the event by taking corrective action and/or logging the event. In the case where specific intervention is desired, that intervention may include the transmission of a notification to a human dispatcher, who may then take action to rectify the situation outside of the system. Alternatively, the system may take action by automatically dispatching a new TR resource to rendezvous or otherwise meet the disabled or failed TR and transfer the load to a new TR. In the case where a TR identifies a security breach (e.g., through an alarm or video monitoring), the TR may report the event to the system, and the system may log the event and/or take predetermined action, such as notifying a security agent or police.

According to additional embodiments, the systems and methods described herein may also feature a just-in-time scheduling and dispatching of TRs. Based on current demand and historical behavior of the system, the scheduling agent may calculate the requirements and availability of TRs to be allocated in order to execute the delivery of loads. During normal use of such a system, the user 130 may need to cancel and reschedule loads as part of ordinary course of business. For instance, in the airline industry, airlines may overbook seating on their planes. The overbooking may be done knowing from past behavior that some percentage of passengers will cancel their booking, reschedule to another flight, or miss their flight for numerous reasons. Accordingly, this practice is done on the airlines in part to maximize capacity utilization (e.g., available seat miles and passenger revenue per available seat mile) for a specific route, flight and overall fleet.

As discussed above, the exemplary systems and methods may utilize machine-based learning and predictive analytics based on data collected in the workflow from creating orders, though execution of a delivery task to completion. For instance, the predictive analytics may implement machine-based learning techniques such as classification (e.g., support vector machines, random forests, and neural networks, etc.), regression and clustering (e.g. K-means, etc.).

Through the initial loading of data and through the workflow process, the loads, TRs, routes and the real-time characteristics of the delivery task execution of those routes may be captured by the system in a database. As the data are collected into the database, values are stored in their original value and are also stored as feature(s) appropriate for use in exemplary machine learning algorithms. For instance, categorical features may include “attribute-value” pairs wherein the value may be restricted to a list of discrete possibilities (e.g., types of TRs, types of load, day of the week, month, tags, cities, regions, streets, etc.). Other data may not be categorical in nature, and thus may be represented as a continuous variable, such as temperature, distance, length or height measured on a continuous scale, etc.

While both categorical and continuous features may be components of any number of calculations, it may be desirable to transform continuous variable into categorical features. For instance, labels may be defined for a new discretely valued categorical feature for available cargo length for a TR with class labels such as, short, medium-length, long, extra-long, etc. Accordingly, continuous values have been transformed from lengths to class labels by defining ranges in length for each label (e.g., binning) or using other techniques know to those skilled in the art. Categorical features may also be summarized, or otherwise grouped, into derived categorical features based on any characteristics of interest. For instance, TR assets that are trucks may be included in a categorical feature that is labeled “truck,” where the original feature may have varied across a plurality of truck types, such as van, SUV, box truck, semi-trailer, etc. Thus, variables may be stored in the database of the system as one of, or a combination of, categorical and continuous values, wherever possible.

Predictive models may play a role in the systems and methods described above, such as the overall operation of method 200 of FIG. 2, wherein one or more predictive models may be employed at each steps 210-290.

For instance, in steps 240-250, automated routing may determine possible routes to be used by a TR to transport a load. Using the identified attributes of the load, TR and the routes, predictions may be made to determine the likelihood of completion or possible delay in the delivery of a load on each of the possible routes and/or segments. For instance, feature selection may be performed on the available features of the load, TRs and the routes to select the set of features that may impact the delivery task decision at hand. It may be noted that the set of features selected from the database will change from time to time.

Supervised learning techniques, as well as other techniques known to those skilled in the art of machine learning, may be applied in the process of feature selection and the implementation of the learning model. For instance, a support vector machine, decision tree or ensemble methods (e.g. “random forests”) of machine learning may be applied to the features to build a model to support the decision of interest.

Furthermore, in step 260, automated dispatching may determine the type and availability of TR assets. Based on the assignment of TRs to the load and the routes, a more comprehensive model may be applied where the feature set available for the predictive model increases based on the new information on the type of TR and attributes specific to a TR.

In the instances where delivery execution has already been initiated in step 280, additional features may be available to enhance the predictive capacity of the models being applied during the automated routing (step 240), automated TR assignment (step 250), automated dispatching (step 260) and delivery execution (step 280). Accordingly, real-time information may become known regarding the execution of the delivery and the monitoring of external information, such as weather, traffic conditions, and unavailable routes, from step 285. Additional information includes details on a particular vehicle dispatched and a specific delivery task execution of the load.

According to one embodiment, a decision tree may serve as a basic example of a supervised learning method model for performing the desired purpose. In this simplified case, the system may track and determine whether a delivery of a load was on time, delayed or failed to complete. The set of features in the database that are relevant to predicting this behavior may be augmented through each step of the method 200 discussed above. As each step from 240-280 occurs, with the additional information from steps 265 and 285, the information content contained within the feature set increases and, thus may potentially provide more predictive power and accuracy in the application of the model.

By augmenting the set of features applied in the model in this example, predictions may capture additional information to enhance both the accuracy and the confidence (e.g., probability of being correct) of the prediction being made. Improving the precision to optimize the automated routing and TR assignment in the dispatching process may increase the probability that the delivery execution is completed on time, with minimum exceptional event(s) or changes. Further, the application of predictive models to assign TRs to routes up to the moment that a TR is required may allow for the system to select an optimal outcome from all of the alternatives that are predicted. For instance, multiple models may be used to optimize selection based on different outcomes, such as lowest predicted price or highest probability of completion. Thus, TR utilization may be maximized while minimizing the operating cost of a TR or fleet of TRs.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving, via a software application, delivery task attributes over a network for delivering a physical load from a source to a destination, the delivery task attributes including at least source specifications, destination specifications and load attributes;
automatically generating routing information for the physical load based on at least one of the delivery task attributes;
automatically assigning a transportation resource to the delivery task based on at least one of the delivery task attributes and transportation resource attributes;
transmitting a dispatch over the network to the assigned transportation resource, the dispatch including the routing information and at least one of the delivery task attributes;
receiving delivery monitoring information during an execution of the delivery task; and
transmitting a notification over the network to at least one of the assigned transportation resource and a user of the software application of the delivery monitoring information.

2. The method according to claim 1, further comprising:
adjusting at least one of the routing information and the assigned transportation resource based on the delivery monitoring information, wherein the delivery monitoring information include real-time route information based on at least one of audio-based monitoring, video-based monitoring, location-based monitoring, environmental condition monitoring and load attribute monitoring; and
transmitting an updated notification over the network to at least one of the assigned transportation resource and a user of the software application of the delivery monitoring information.

3. The method according to claim 1, further comprising:
storing the routing information, delivery task attributes and transportation resource attributes into a historical database; and
generating a predictive model for optimizing future delivery tasks, wherein the optimizing includes automatically generating further routing information and automatically assigning a further transportation resource during a time period including at least one of prior to the execution of the delivery task, during the execution of the delivery task, and at the completion of the execution of the deliver task.

4. The method according to claim 3, wherein the predictive model is generated using supervised learning techniques wherein a feature set used within the predictive model is augmented throughout the delivery task process as additional features become available.

5. The method according to claim 1, wherein the software application uses machine-to-machine interactions for at least one of the receiving delivery task attributes, transmitting the dispatch, receiving delivery monitoring information, and transmitting the notification.

6. The method according to claim 1, wherein the transportation resources attributes includes at least one of an availability of the transportation resource, a location of the transportation resource, a scheduled use of the transportation resource, and a current capacity of a resource provider.

7. The method according to claim 1, wherein the assigned transportation resource includes the use of a third-party resource, and the generated routing information include real-time scheduling of the third-party resource.

8. A server, comprising:
a memory storing a plurality of rules; and
a processor coupled to the memory and configured to perform actions that include:
receiving, via a software application, delivery task attributes over a network for delivering a physical load from a source to a destination, the delivery task attributes including at least source specifications, destination specifications and load attributes;
generating routing information for the physical load based on at least one of the delivery task attributes;
assigning a transportation resource to the delivery task based on at least one of the delivery task attributes and transportation resource attributes;
transmitting a dispatch over the network to the assigned transportation resource, the dispatch including the routing information and at least one of the delivery task attributes;
receiving delivery monitoring information during an execution of the delivery task; and
transmitting a notification over the network to at least one of the assigned transportation resource and a user of the software application of the delivery monitoring information.

9. The server according to claim 8, wherein the actions performed by the processor further comprise:
adjusting at least one of the routing information and the assigned transportation resource based on the delivery monitoring information, wherein the delivery monitoring information include real-time route information at least one of audio-based monitoring, video-based monitoring, location-based monitoring, environmental condition monitoring and load attribute monitoring; and
transmitting an updated notification over the network to at least one of the assigned transportation resource and a user of the software application of the delivery monitoring information.

10. The server according to claim 8, wherein the actions performed by the processor further comprise:
storing the routing information, delivery task attributes and transportation resource attributes into a historical database; and
generating a predictive model for optimizing future delivery tasks, wherein the optimizing includes automatically generating further routing information and automatically assigning a further transportation resource during a time period including at least one of prior to the execution of the delivery task, during the execution of the delivery task, and at the completion of the execution of the deliver task.

11. The server according to claim 10, wherein the predictive model is generated using supervised learning techniques wherein a feature set used within the predictive model is augmented throughout the delivery task process as additional features become available.

12. The server according to claim 8, wherein the software application uses machine-to-machine interactions for at least one of the receiving delivery task attributes, transmitting the dispatch, receiving delivery monitoring information, and transmitting the notification.

13. The server according to claim 8, wherein the transportation resources attributes includes at least one of an availability of the transportation resource, a location of the transportation resource, a scheduled use of the transportation resource, and a current capacity of a resource provider.

14. The server according to claim 8, wherein the assigned transportation resource includes the use of a third-party resource, and the generated routing information include real-time scheduling of the third-party resource.

15. A non-transitory computer readable storage medium with an executable program stored thereon, wherein the program instructs a processor to perform actions that include:
receiving delivery task attributes over a network for delivering a physical load from a source to a destination, the delivery task attributes including at least source specifications, destination specifications and load attributes;
automatically generating routing information for the physical load based on at least one of the delivery task attributes;
automatically assigning a transportation resource to the delivery task based on at least one of the delivery task attributes and transportation resource attributes;
transmitting a dispatch over the network to the assigned transportation resource, the dispatch including the routing information and at least one of the delivery task attributes;
receiving delivery monitoring information during an execution of the delivery task; and
transmitting a notification over the network to at least one of the assigned transportation resource and a user of the software application of the delivery monitoring information.

16. The non-transitory computer readable storage medium according to claim 15, wherein the program further instructs the processor to:
adjust at least one of the routing information and the assigned transportation resource based on the delivery monitoring information, wherein the delivery monitoring information include real-time route information at least one of audio-based monitoring, video-based monitoring, location-based monitoring, environmental condition monitoring and load attribute monitoring; and
transmit an updated notification over the network to at least one of the assigned transportation resource and a user of the software application of the delivery monitoring information.

17. The non-transitory computer readable storage medium according to claim 15, wherein the program further instructs the processor to:
store the routing information, delivery task attributes and transportation resource attributes into a historical database; and
generate a predictive model using supervised learning techniques wherein a feature set used within the predictive model is augmented throughout the delivery task process as additional features become available for optimizing future delivery tasks, wherein the optimizing includes automatically generating further routing information and automatically assigning a further transportation resource during a time period including at least one of prior to the execution of the delivery task, during the execution of the delivery task, and at the completion of the execution of the deliver task.

18. The non-transitory computer readable storage medium according to claim 15, wherein the program uses machine-to-machine interactions for at least one of the receiving delivery task attributes, transmitting the dispatch, receiving delivery monitoring information, and transmitting the notification.

19. The non-transitory computer readable storage medium according to claim 15, wherein the transportation resources attributes includes at least one of an availability of the transportation resource, a location of the transportation resource, a scheduled use of the transportation resource, and a current capacity of a resource provider.

20. The non-transitory computer readable storage medium according to claim 15, wherein the assigned transportation resource includes the use of a third-party resource, and the generated routing information include real-time scheduling of the third-party resource.
